(19) United States
(12) Patent Application Publication
(10) Pub. No.: US 2007/0181244 A1
(43) Pub. Date: Aug. 9, 2007

(54) Device and method for wrapping or bundling objects

(76) Inventors: Heinrich Billing, Haunetal (DE); Berthold Hahn, Nuesttal (DE)

Correspondence Address: THE PROCTER & GAMBLE COMPANY;INTELLECTUAL PROPERTY DIVISION - WEST BLDG., WINTON HILL BUSINESS CENTER - BOX 412, 6250 CENTER HILL AVENUE, CINCINNATI, OH, 45224, US

(21) Appl. No.: 11/599,856

(22) Filed: Nov. 15, 2006

(30) Foreign Application Priority Data
Nov. 15, 2005 (EP) 05024955.6

(51) Int. Cl. B65C 1/04; B29D 22/00; B65C 3/16; B65C 9/36

(52) U.S. Cl. 156/213; 156/476; 156/484; 156/485; 156/215

(57) ABSTRACT

With a device (1) to wrap or bundle objects, particularly cables (2), wherein the objects are insulated, connected to each other, or affixed to each other using adhesive tape (3) that is wrapped around them, particularly adhesive tape, a tape placement system (6) is used to supply the tape. The tape placement system (6) has a disk (11) that can rotate around an axis (10). Two placement rollers (12) are provided, whose axes (13) are mounted on the disk (11) in a fixed location. A placement roller (16), which is mounted on a lever (14) and rotatable using an axis (15), is connected to the disk (11) in a swiveling manner in such a way that the lever (14) is connected to the disk (11) via a pivot joint (17), and the lever (14) is pre-loaded on the disk (11) via a spring (18) opposite a mounting point (19). A drive (20) is provided for driving the disk (11), so that when the three placement rollers (12,16) circulate around the object or objects, the placement rollers (12,16) guide the tape (3) around the object or objects.

The object of the application relates, in particular, to vehicle manufacturing and the wrapping of cables therein in order to insulate them, the bundling of cables in order to provide them in the form of cable harnesses for providing electricity to motor vehicles, and the connecting of two contiguous contact points between two cables to be connected.

A device for wrapping or bundling objects, particularly cables, is known from European Patent No. 0 621 182 A1, wherein the objects are insulated, connected to each other, or affixed to each other using adhesive tape that is wrapped around them. A supply roll with a feed is used to supply and further feed the tape up to a tape placement system. The tape placement system is provided to wrap a section of the tape around the objects. A separation device is used to separate each section of the tape and a switch is used to start the wrapping process.

The known device has the disadvantage that a flat belt, which has a relatively complicated convolution, is used to drive an adjustable roller mechanism in order to execute the wrapping process. This type of flat belt is subject to malfunctions.

Thus, the object of the present invention is to provide a solution for this disadvantage.

The tape placement system has a disk that rotates around an axis. There are placement rollers provided whose axes are fixed in position on the disk. A third placement roller, which is mounted on a lever and rotatable using an axis, is connected to the disk in a swiveling manner so that the lever is connected to the disk via a pivot joint, and the lever is pre-loaded on the disk via a spring opposite a mounting point. A drive is used to drive the disk.

A tape with an adhesive side is initially placed against the object or objects, and the object or objects is (are) placed, along with the adhering tape, between the three placement rollers. On one side, two placement rollers are placed up against the object or objects and, on the other side, one placement roller is placed up against the object or objects, wherein the placement rollers are rotatable around their axes that are aligned parallel to the object or objects, so that when the three placement rollers circulate around the object or objects, the placement rollers wrap the tape around the object or objects. The tape is separated on the feed side.

The proposed device and the proposed method have the advantage that, in a reliable and simple manner, cables can be wrapped up or bundled. Three placement rollers, which are connected to a disk in a stable and rotatable manner, are then used to fix the object to be wrapped up between them. In so doing, the object has a stable position in that it can be placed in a depression between the two first placement rollers. The third placement roller is then placed up against the object using spring and lever force from an opposing side; the roller thereby adjusts to the object diameter. Due to rotation of the disk, all three placement rollers roll around the object with their jacket areas and wrap the object with the tape, which is typically adhesive tape. It does not matter whether an oblong object is held in position or is moved in the direction of its longitudinal extension. Thus, simple bundling or coil-like wrapping, e.g., of a cable bundle, is possible without the cable bundle being twisted.

Advantageous embodiments of the proposed device are:

A particularly smooth circulation of the three placement rollers around the object to be wrapped up, i.e. an object or multiple objects, is achieved with a bundle of objects or object inserted into the tape placement system, the distances between the axis of each placement roller and the axis of the disk are the same or approximately the same. With this setup for the position of the axes, the rollers rotate equidistantly around the axis of the disk.

If a stepper motor, which transfers its rotational movement to a cogwheel coaxially connected to the disk via a closed toothed belt, is used as a drive to drive the disk, one wrapping process is carried out per actuation and the transfer of the rotational movement occurs without slippage as well.

A smooth-running continued movement of adhesive tape is obtained if the feed has a system of three rollers, wherein two rollers are driven at various speeds by a drive consisting of a toothed belt with coaxial cogwheels of various diameters, so that both rollers further transport the tape, the adhesive side of which is placed against both rollers, and the tape is pulled from the previous roller through the next roller of adhesive tape in the direction of tape transport. In this process, the third roller is used to place the tape on the previous roller. Using this technology, there is no malfunctioning adhesion of the adhesive tape on the center roller, which has a particularly large adhesive surface.

Stepper motors, which are synchronized with each other, are suitable as drives for the disk and for the feed.

If a lever system extends between a joint connected to the switch and at least one affixed joint point, wherein a spring is provided to reset the lever system which was offset by the switch, and a free lever end of the lever system acts upon the free end of the lever of the third placement roller, in order to swivel the lever of the third placement roller away from the first two placement rollers, this will ensure that the tape placement system is opened in a simple manner via actuation of the switch, to facilitate better introduction of the object to be wrapped up.

Various tape wrappings can be executed without having to mechanically reset the device if a programming device, preferably with a display, with said device being connected to the drives via a power supply, is provided to preselect a certain length of the sections, a certain number of rotations of the disk for a wrapping process, or a forwards/backwards run of the drives, which is required for flag creation on the bundle. A preselected setting, for example three layers of tape for a winding process, can then be read off of the display.

If a microswitch is provided, which can be activated by the switch to dispense tape before a wrapping process via actuation of the switch as well as to actuate the separation device and the drive for driving the disk after the spring-loaded switch has been released, this results in the obtainment of several advantages. On one hand, a sufficiently long piece of tape is dispensed before a wrapping process in order to enable placement of the object to be wrapped up on said tape. While on the other hand, the switch can be released after the object has been successfully inserted and thereby start the wrapping process and the provision of a section of tape can be assured.

A connection, which is displaceable using an actuator cylinder, is suitable for actuating the separation device.

The device is suitable for mobile manual use if it is designed as a hand-held unit with a handle.

The invention is described in detail below with reference to figures that show an exemplary embodiment. The following is shown:

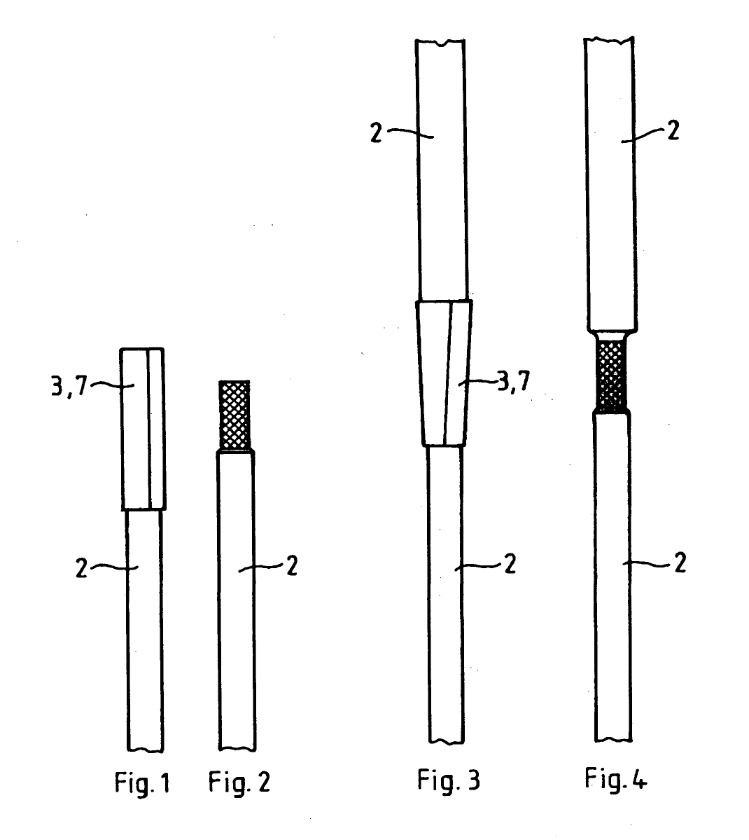

FIG. 1 shows a top view of cable with insulation provided by wrapped up adhesive tape;

FIG. 2 shows a top view of the cable from FIG. 1, but without insulation;

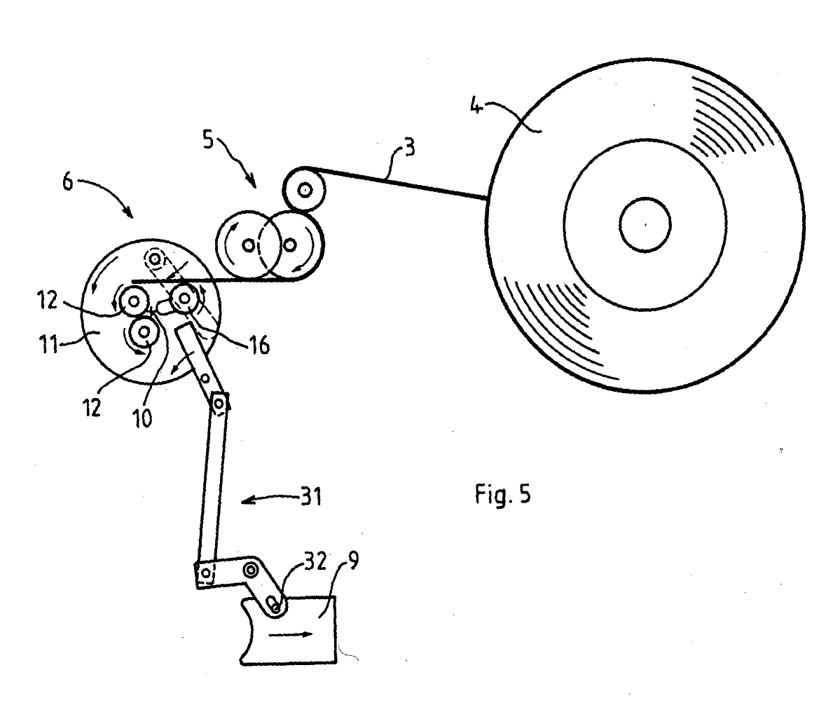

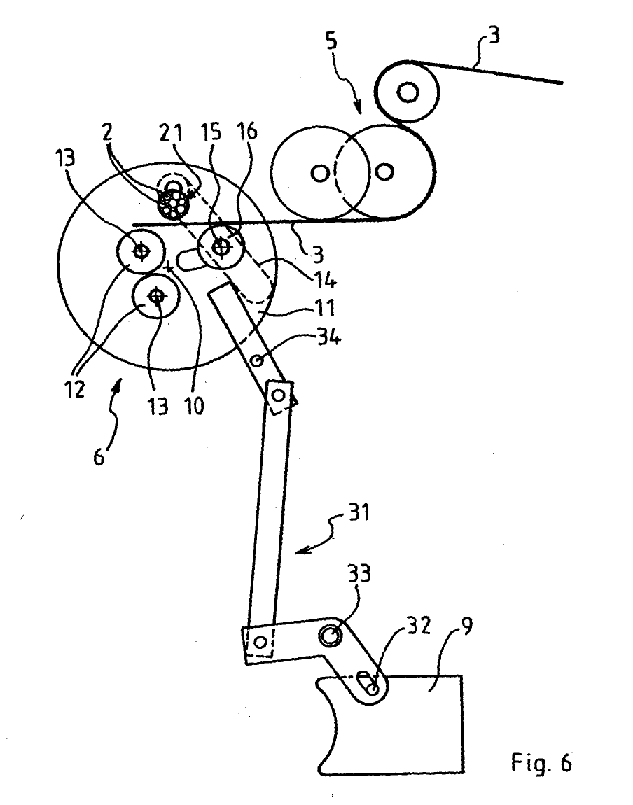

FIG. 3 shows a top view of two sections of cable having an insulated passageway connection;

FIG. 4 shows a top view of the cable from FIG. 3, but without insulation around the conducting passageway connection;

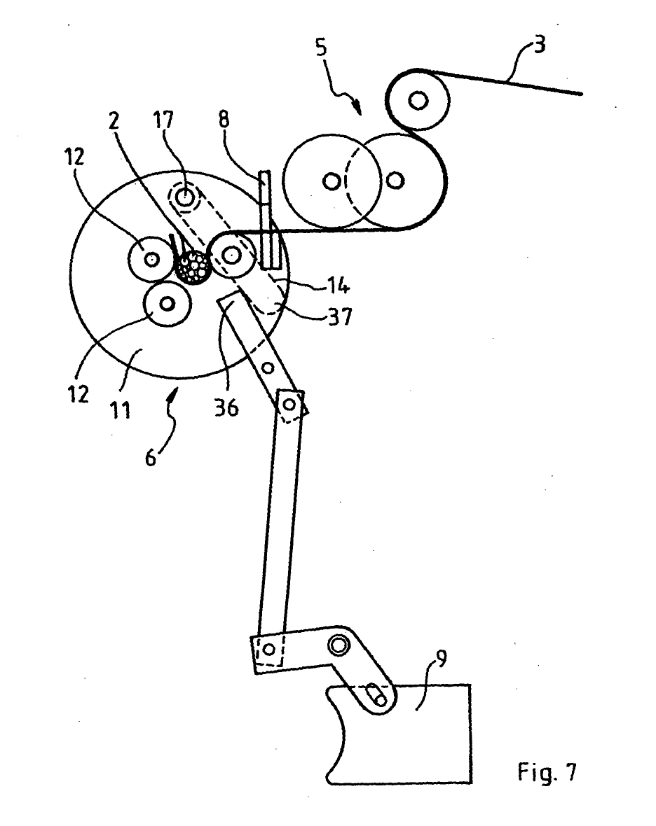

FIG. 5 shows a side view of a part of a device to wrap up a bundle of cables using adhesive tape;

FIG. 6 shows a side view of a cut-out of the device from FIG. 5, but with the addition of a previously prepared bundle;

FIG. 7 shows a side view of the object from FIG. 6, but with a bundle inserted into a tape placement system of the device and with a separation device to separate the tape;

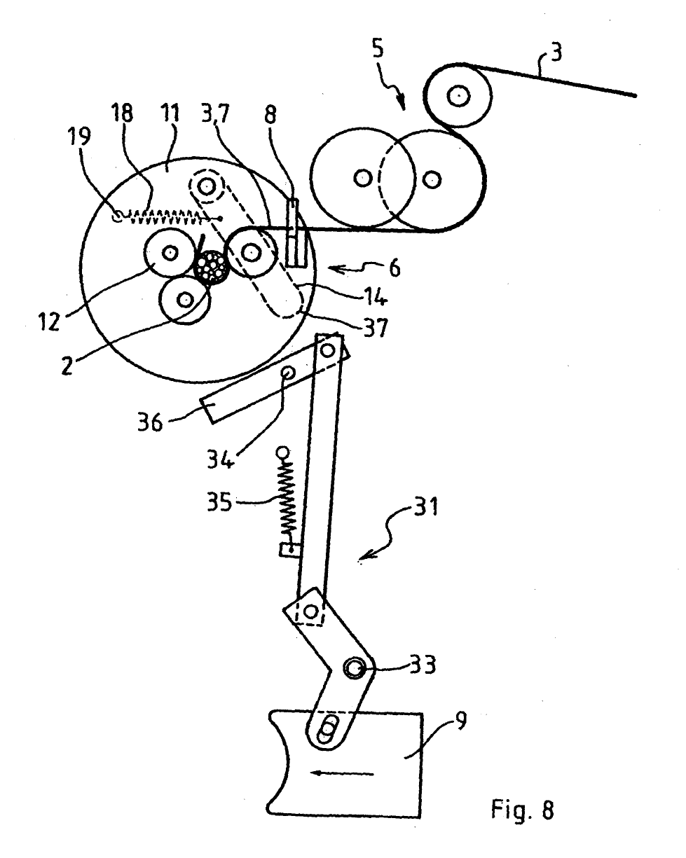

FIG. 8 shows a side view of the object from FIG. 7, but in the subsequent process step, wherein the tape is separated, and, in addition, there are two springs of the device;

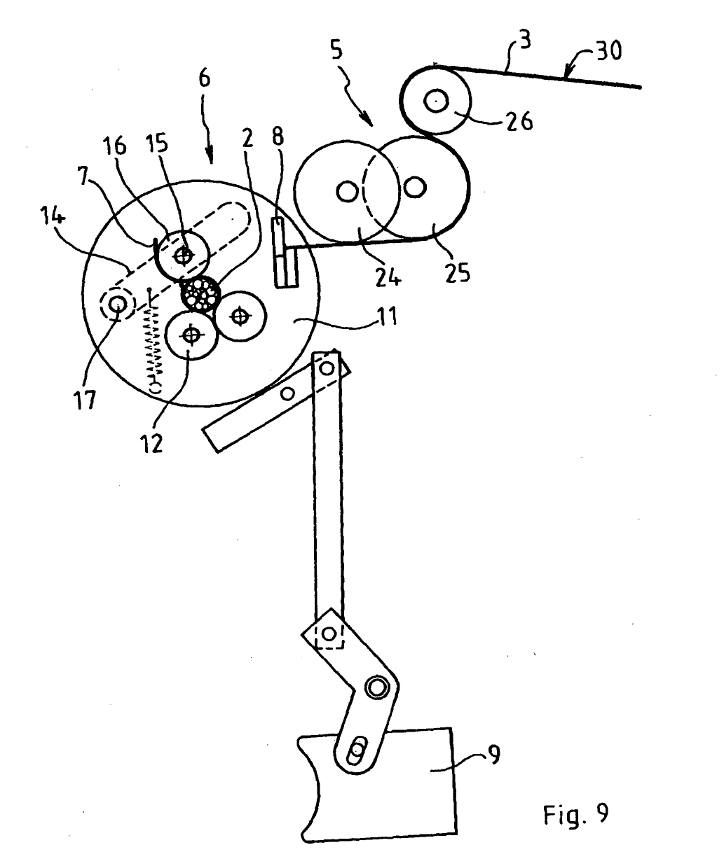

FIG. 9 shows a side view of the object from FIG. 8, but in an additional wrapped condition;

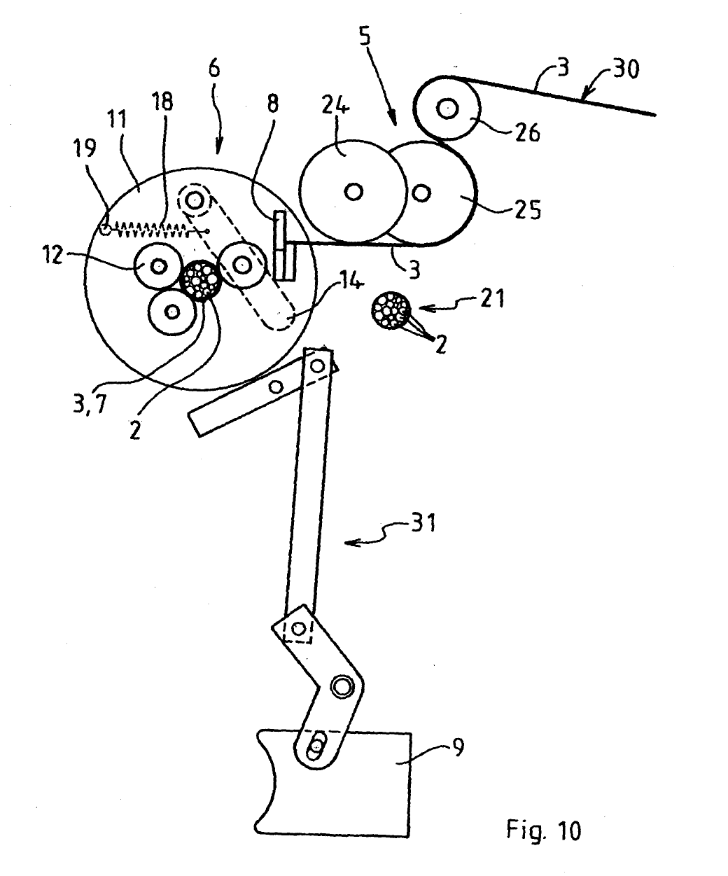

FIG. 10 shows a side view of the object from FIG. 9, but with a completely wrapped bundle and with an additional bundle of cable yet to be wrapped;

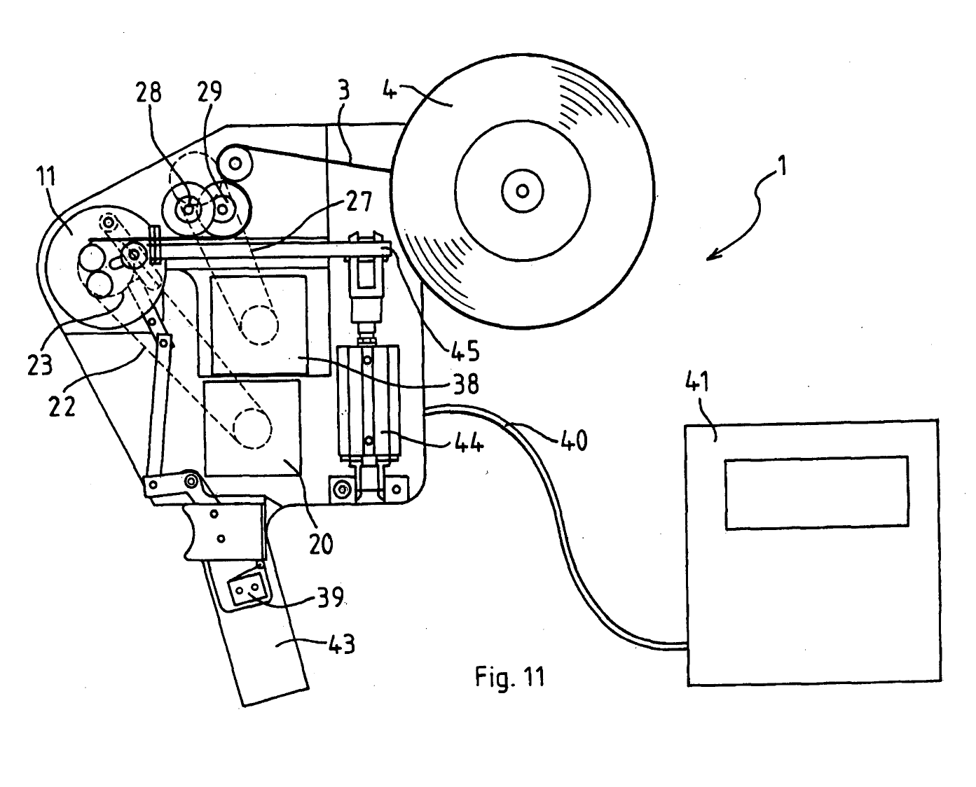

FIG. 11 shows a side view of a complete device; and

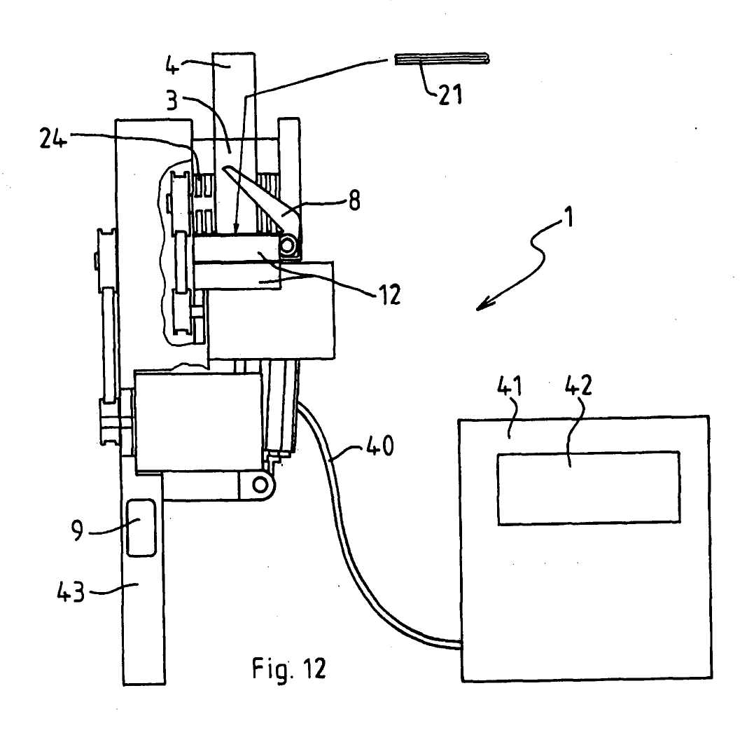

FIG. 12 shows a side view of the object from FIG. 11, wherein a part of the device has been rotated by 90 degrees.

A device 1 (FIGS. 11 and 12) is used to wrap cable points (FIGS. 1 through 4) and to bundle cables (FIGS. 5 through 10). In doing so, the mode of operation of the device is the same in each case. In both cases, the objects are insulated, connected to each other, or affixed to each other using tape 3, which is wrapped around them, and which is adhesive tape.

A device (FIGS. 5 through 12) with a supply roll 4 has a feed 5 to pull the tape 3 from the supply roll 4 and to further move the tape 3 up to a tape placement system 6. In doing so, the tape placement system 6 is provided to wrap a section 7 of the tape 3 around the objects. A separation device 8 is used to separate each section 7 of the tape 3 and a switch 9 is used to start a wrapping process.

The tape placement system 6 has a disk 11 that can rotate around an axis 10. There are two placement rollers 12 provided, whose axes 13 are mounted onto the disk 11 in a fixed position with respect to the disk 11. A placement roller 16 rotatably mounted to a lever 14 using an axis 15 is connected to the disk 11 in a swiveling manner. To that end, the lever 14 is connected to the disk 11 via a pivot joint 17. The lever 14 is pre-loaded on the disk 11 via a spring 18 opposite a mounting point 19. A drive 20 is provided to drive the disk 11.

With a bundle 21 of cables 2 inserted into the tape placement system 6, the distances, each of which extend between one axis 13,15 of a placement roller 12,16 and the axis 10 of the disk 11, are approximately the same, so that, when the bundle 21 is wrapped with a section 7 of the tape 3, the convolution of the three placement rollers 12,16 around the bundle 21 is smooth.

To enable a convolution of the placement rollers 12,16 three times, the disk 11 is rotated three times, which causes the three layers of tape 3 to be wrapped around the bundle. A stepper motor, which transfers its rotational movement to a cogwheel 23 coaxially connected to the disk 11 via a closed toothed belt 22, is provided as a drive 20 to drive the disk 11.

A feed 5 is used to dispense a required section 7 of the tape 3 that is needed for a wrapping process. In doing so, a small piece of tape 3 is dispensed before a bundle insertion to then be able to place the bundle 21 on an adhesive side 30 of the tape 3, before the disk 11 is rotated. The feed 5 has a system of three rollers 24,25,26, wherein two rollers 24,25 are driven at various speeds by a drive 38 consisting of a toothed belt 27 with coaxial cogwheels 28,29 of various diameters, so that both rollers 24,25 further transport the tape 3, the adhesive side 30 of which is placed against both rollers 24,25, and the tape is pulled from the previous, slower driven roller 25 through the next, faster rotating roller 24 of adhesive tape 3 in the direction of tape transport. The third roller 26 is used to place the tape 3 on to the previous roller 25. The drives 20,38 are stepper motors, which are synchronized with each other.

A lever system 31 is connected to the switch 9 and the lever 14 in order to swivel the lever 14, upon which the swiveling placement roller 16 is rotatably mounted, away from the placement roller 12 before a binding process, to enable insertion of a bundle 21 into the tape placement system 6, and, with the bundle 21 inserted, to then subsequently enable placement of the third placement roller 16 onto the tape 3 and thus onto the bundle 21. The lever system 31 extends between a joint 32 connected to the switch 9 and two affixed joint points 33,34. A spring 35 is provided to reset the lever system 31, which was offset by the switch 9. A free lever end 36 acts upon the free end 37 of the lever 14 to swivel the lever 14 of the disk 11 away from the placement rollers 12. When the switch 9 is released, the spring 35 pulls the lever system 31 back, whereby the lever 14 of the disk 11 is released. In addition, a microswitch 39 is provided, which can be activated by the switch 9, to dispense tape before a wrapping process via actuation of the switch 9 as well as to actuate the separation device 8 and the drive 20 for driving the disk 11 after the spring-loaded switch 9 has been released. Thus, a complete wrapping process is initiated via actuation and subsequent release of the switch 9. Furthermore, a programming device 41, with a display 42, with said device being connected to the drives 20 via a power supply 40, is provided to preselect a certain length of the sections 7 and the number of three rotations of the disk 11 for a wrapping process. Alternatively, it would also possible to preselect a forwards/backwards run of the drives 20,38, which would be required for flag creation on the bundle 21.

To that end, an actuator cylinder 44 is provided to actuate the separation device 8 via a connection 45.

The device 1, which has a handle 43 and is executed as a hand-held unit, is operated so that the tape 3 is always placed up against the cable 2 to be bundled with the adhesive side 30, and so that the cable 2, along with the adhering tape 3, is always placed between the three placement rollers 12,16.

This ensures that both placement rollers 12 on one side as well as the placement roller 16 on the other side are placed up against the bundle 21 of cables 2. The three placement rollers 12,16, which are rotatable around their axes 13,15 that are parallel to the object or bundle 21, wrap the bundle 21 and the tape around the bundle upon a convolution of the disk 11. The tape 3 is separated on the feed side dependent on the section length.

1 Device

2 Cable

3 Tape

4 Supply roll

5 Feed

6 Tape placement system

7 Section

8 Separation device

9 Switch

10 Axis

11 Disk

12 Placement roller

13 Axis

14 Lever

15 Axis

16 Placement roller

17 Pivot joint

18 Spring

19 Mounting point

20 Drive

21 Bundle

22 Toothed belt

23 Cogwheel

24,25,26 Roller

27 Toothed belt

28,29 Cogwheel

30 Adhesive side

31 Lever system

32 Joint

33,34 Affixed joint point

35 Spring

36 Lever end

37 Free end

38 Drive

39 Microswitch

40 Power supply

41 Programming device

42 Display

43 Handle

44 Actuator cylinder

45 Connection

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm”.

All documents cited in the Detailed Description of the Invention are, in relevant part, incorporated herein by reference; the citation of any document is not to be construed as an admission that it is prior art with respect to the present invention. To the extent that any meaning or definition of a term in this written document conflicts with any meaning or definition of the term in a document incorporated by reference, the meaning or definition assigned to the term in this written document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A device to wrap or bundle objects, particularly cables, wherein the objects are insulated, connected to each other, or affixed to each other using adhesive tape that is wrapped around them, with a supply roll and a feed to pull the tape off of the supply roll and to further move the tape up to a tape placement system, wherein the tape placement system is provided to wrap a section of the tape around the objects, with a separation device to separate each individual section of tape, as well as a switch to start a wrapping process, wherein the tape placement system has a disk that can rotate around an axis, wherein two placement rollers are provided, whose axes are mounted on the disk in a fixed location, wherein a placement roller rotatably mounted to a lever using an axis is connected to the disk in a swiveling manner, wherein the lever is pre-loaded on the disk via a spring opposite a mounting point, and wherein a drive is provided for driving the disk.

2. The device according to claim 1, wherein, with a bundle of objects or object inserted into the tape placement system, the distances between the axis of each placement roller and the axis of the disk are the same or approximately the same in each case.

3. The device according to claim 1, wherein a stepper motor, which transfers its rotational movement to a cogwheel coaxially connected to the disk via a closed toothed belt, is provided as a drive to drive the disk.

4. The device according to claim 1, wherein the feed has a system of three rollers, wherein two rollers are driven at various speeds by a drive consisting of a toothed belt with coaxial cogwheels of various diameters, so that both rollers further transport the tape, the adhesive side of which is placed up against the rollers, and the tape is pulled from the previous roller through the next roller in the direction of tape transport, and the third roller is used to place the tape on the previous roller.

5. The device according to claim 4, wherein stepper motors, which are synchronized with each other, are provided as drives.

6. The device according to claim 1, wherein a lever system extends between a joint connected to the switch and at least one affixed joint point, wherein a spring is provided to reset the lever system, which was offset by the switch, and wherein a free lever end acts upon the free end of the lever to swivel the lever of the disk away from the placement rollers.

7. The device according to claim 1, wherein a microswitch is provided, which can be activated by the switch, to dispense tape before a wrapping process via actuation of the switch as well as to actuate the separation device and the drive for driving the disk after the spring-loaded switch has been released.

8. The device according to claim 1, wherein a programming device, preferably with a display, with said device being connected to the drives via a power supply, is provided to preselect a certain length of the sections, a certain number of rotations of the disk for a wrapping process, or a forwards/backwards run of the drives, which is required for flag creation on the bundle.

9. The device according to claim 1, wherein an actuator cylinder is provided for actuating the separation device via a connection.

10. The device according to claim 1, wherein the device is designed as a hand-held unit with a handle.

11. A method for wrapping an oblong object or multiple oblong objects, particularly cable, wherein, initially, a tape with an adhesive side is placed against the object or objects, and the object or objects is (are) placed, along with the adhering tape between the three placement rollers, wherein, on one side, two placement rollers are placed up against the object or objects and, on the other side, one placement roller is placed up against the object or objects, wherein the placement rollers are rotatable around their axes that are aligned parallel to the object or objects, so that when the three placement rollers circulate around the object or objects, the placement rollers wrap the tape around the object or objects, and the tape is separated on the feed side.
